(19) United States
(12) Patent Application Publication
(10) Pub. No.: US 2008/0263064 A1
(43) Pub. Date: Oct. 23, 2008

(54) FILE PROCESSING METHOD AND APPARATUS FOR MOBILE TERMINAL USING AN EXTERNAL DEVICE

(75) Inventor: Yeon Kyu CHOI, Gumi-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/947,447

(22) Filed: Nov. 29, 2007

(30) Foreign Application Priority Data
Apr. 20, 2007 (KR) 10-2007-0038818

(51) Int. Cl. G06F 17/30

(52) U.S. Cl. 707/100

(57) ABSTRACT

The present invention relates to a file processing method and an apparatus for a mobile terminal using an external device. The file processing apparatus includes a storage unit to store files, and a control unit to divide a data file into a file header and a file body, to store the file header in the storage unit, and to store the file body in an external device. The file header and the file body of the data file can be stored separately.

### CROSS REFERENCE TO RELATED APPLICATION

This application claims priority from and the benefit of Korean Patent Application No. 10-2007-0038818, filed on Apr. 20, 2007, which is hereby incorporated by reference for all purposes as if fully set forth herein.

### BACKGROUND OF THE INVENTION

1. Field of the Invention

The present invention relates generally to a mobile terminal and, more particularly, to a file processing method and an apparatus for a mobile terminal using an external device.

2. Discussion of the Background

Advances in information and communication technologies have popularized mobile terminals. In addition to conventional phone call processing, modern mobile terminals support multimedia features, such as camera photographing, music playing, and the like. Data file sizes have gradually increased with these multimedia features.

In particular, high capacity storage media are necessary to store high quality images and motion pictures. However, a mobile terminal may have limited storage capacity due to its physical size.

To overcome this problem, advanced mobile terminals may support removable storage media. Removable storage media may be convenient and economical.

However, removable storage media may create vulnerabilities with regard to information security. That is, removable storage media may be lost or stolen, which may result in the leaking of sensitive information and an invasion of privacy.

### SUMMARY OF THE INVENTION

The present invention provides a file processing method and an apparatus for a mobile terminal using an external device, wherein a data file stored in the external device may be difficult for persons other than the owner to access.

Additional features of the invention will be set forth in the description which follows, and in part will be apparent from the description which follows, and in part will be apparent from the description, or may be learned by practice of the invention.

The present invention discloses a file processing apparatus for a mobile terminal including a storage unit to store files and a control unit to divide a data file into a file header and a file body, to store the file header in the storage unit, and to store the file body in an external device.

The present invention also discloses a file storing method for a mobile terminal connected to an external device, including dividing a data file into a file header and a file body in response to a command signal to store the data file, storing the file header in a storage unit of the mobile terminal, and storing the file body in the external device.

The present invention also discloses a file restoring method for a mobile terminal connected to an external device, including reading a file header and a file body corresponding to a data file in response to a command signal to play data file and combining the file header and the file body together to restore the data file.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a data file processing method using an external device, according to an exemplary embodiment of the present invention.

FIG. 2 shows a configuration of a mobile terminal using an external device, according to another exemplary embodiment of the present invention.

FIG. 3 is a flow chart showing a file storing procedure in the data file processing method of FIG. 1.

FIG. 4 is a flow chart showing a file restoring procedure in the data file processing method of FIG. 1.

FIG. 5 is a flow chart showing a procedure of utilizing an external device.

FIG. 6 is a flow chart showing a procedure of performing an optional function using an external device.

FIG. 7 shows a screen representation for the procedure of FIG. 6.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Although, for the purpose of description, a mobile communication terminal is described as an example of the mobile terminal of exemplary embodiments of the present invention, the present invention is not limited to a mobile communication terminal. The mobile terminal of the present invention may be any information and communication appliance or multimedia appliance, such as a mobile communication terminal, a digital broadcast receiving terminal, a personal digital assistant, a smart phone, an international mobile telecommunications 2000 (IMT 2000) terminal, a wideband code division multiple access (WCDMA) terminal, and a universal mobile telecommunications system (UMTS) terminal.

An electronic appliance having a central processing unit (CPU) and storage media, such as a main memory, hard disk, and removable disk, may process various files. In general, files may be divided into executable files and data files. An executable file is a file for performing a particular function. A data file may be input to an associated executable file during the execution of the executable file. When an executable file is executed by the CPU, a data file having a predefined format should be input to the executed executable file to produce expected results.

Exemplary embodiments of the present invention provide a data file processing method that may be capable of increasing data file security.

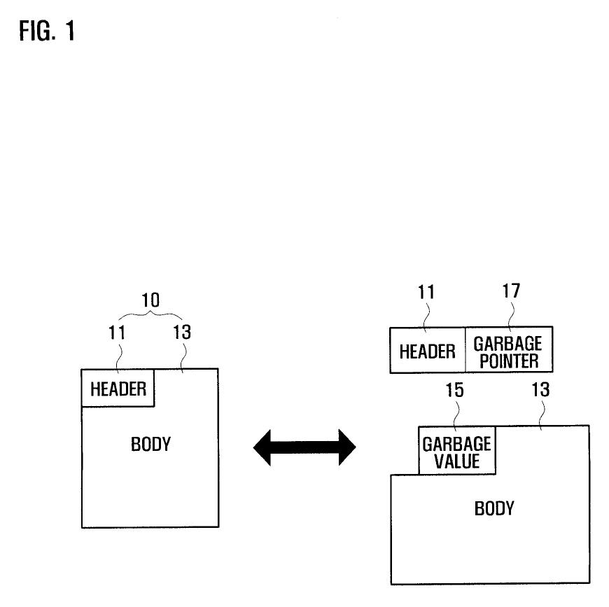

FIG. 1 shows a data file processing method using an external device according to an exemplary embodiment of the present invention.

Referring to FIG. 1, a data file 10 includes a file header 11 and a file body 13. The file body 13 contains actual data, and the file header 11 contains information on the data in the file body 13 such as a type, a size, and a format.

The data in the file body 13 can only be accessed using the information in the file header 11. That is, the data in the file body 13 cannot be read without the information in the file header 11.

Because of this, in exemplary embodiments of the present invention, when a data file 10 is stored, the file header 11 and file body 13 of the data file 10 are stored separately from each other.

The size of the file header 11 may be less than that of the file body 13. Hence, the file header 11 can be stored in a storage unit of a mobile terminal, and the file body 13 can be stored in an external device that is removably connected to the mobile terminal. The external device may be a high capacity removable storage medium, such as a disk.

The separately stored file header 11 and file body 13 may be combined together into the original data file 10 using a preset algorithm if necessary.

Separate storage of the file header 11 and file body 13 may increase the level of file security. That is, it may not be possible to restore a data file 10 to its original form without knowing the manner in which the file header 11 is to be combined with the file body 13.

To further increase the level of file security, a garbage value 15 can be inserted into the file body 13, and a garbage pointer field 17 containing data regarding the garbage value 15, such as its size and start location, can be added to the file header 11. When the original data file 10 is restored, the garbage value 15 can be removed using the garbage pointer field 17.

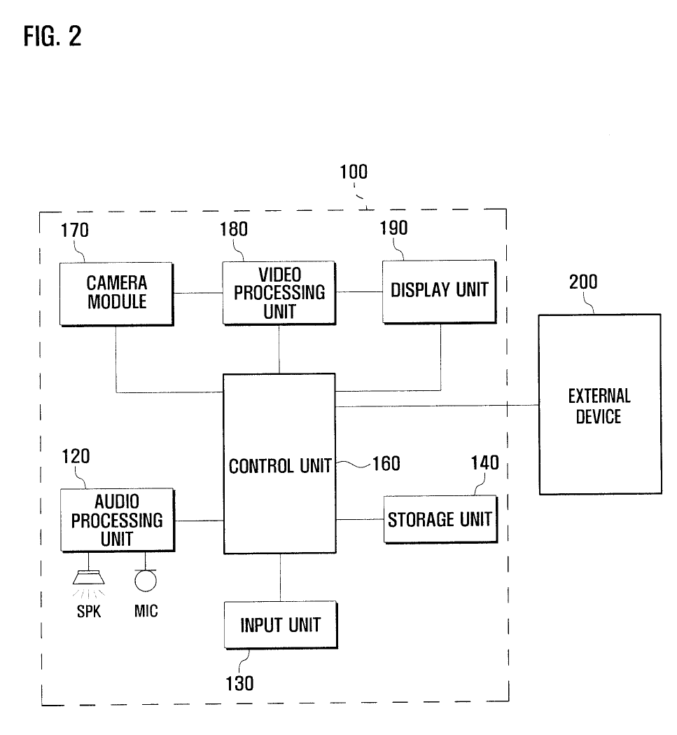

FIG. 2 shows a configuration of a mobile terminal 100 using an external device, such as a removable storage medium, according to another exemplary embodiment of the present invention.

Referring to FIG. 2, the mobile terminal 100 includes an audio processing unit 120, an input unit 130, a storage unit 140, a control unit 160, a camera module 170, a video processing unit 180, and a display unit 190. In addition, an external device 200, which may be a removable storage medium, is connected to the mobile terminal 100 to store various data. The external device 200 can have a unique media identifier (for example, a serial number) that allows it to be distinguished from other removable storage media. Hence, when an external device, such as a removable storage medium, is connected to the mobile terminal 100, the mobile terminal 100 can identify the external device using the media identifier.

The external device 200 may be a memory card, such a hard disk, a random access memory (RAM) card, a flash memory card, a memory stick, or a smart card. Alternatively, the external device 200 may be a digital appliance having a storage medium. Although not shown, the mobile terminal 100 may further include a media slot into which an external device 200 for data storage may be inserted and a connector to connect the mobile terminal 100 to an external digital appliance for data exchange.

The audio processing unit 120 reproduces an audio signal from the control unit 160 through a speaker SPK and sends an audio signal, such as a voice signal, from a microphone MIC to the control unit 160.

The input unit 130 includes a plurality of alphanumeric and function keys for inputting alphanumeric information and setting various functions. The function keys may include direction, side, and shortcut keys associated with corresponding functions. The input unit 130 transmits key signals to set and control the mobile terminal 100 from the user to the control unit 160.

The storage unit 140 stores application programs for exemplary embodiments of the present invention, downloaded digital contents, and data created by the user.

The storage unit 140 may include a program storage section and a data storage section. The program storage section may store an operating system to boot the mobile terminal 100 and application programs for supplementary functions, such as photographing and music playing. The data storage section may store user data, such as music files and motion picture files, generated from the use of the mobile terminal 100.

In particular, when a data file 10 is stored, the file header 11 of the data file 10 can be stored in the data storage section. That is, the file header 11 can be stored in a folder of the data storage section associated with the external device 200. When two or more external device 200 are used, folders corresponding to media identifiers of the external device 200 may be created by the control unit 160.

The storage unit 140 may provide a buffer space to temporarily store user data, such as songs, still images, and moving images, generated from execution of application programs related to, for example, photographing, music playing, and video playing.

The control unit 160 may control the camera module 170 to obtain a data signal by photographing a target object and convert the data signal into an image signal using an encoder (not shown) for further processing.

The video processing unit 180 converts an analog signal, such as an image signal from the camera module 170, into a digital signal. The video processing unit 180 may generate screen data to display an image signal from the camera module 170. That is, the video processing unit 180 may compress or decompress screen data according to display characteristics of the display unit 190.

The display unit 190 displays various menus of the mobile terminal 100, information input by the user, function setting information, and prompts for information to be provided to the user. The display unit 190 may include a liquid crystal display (LCD) panel, an LCD controller to control the LCD panel, and a video memory to store video data.

The control unit 160 controls the overall operation of the mobile terminal 100 and signal exchange between internal elements thereof. That is, the control unit 160 controls signal exchange between the audio processing unit 120, the input unit 130, the storage unit 140, the camera module 170, the video processing unit 180, and the display unit 190.

The control unit 160 performs functions of the mobile terminal 100 according to key signals input through the input unit 130 or touch events through a touch screen and displays corresponding operation states and menus through the display unit 190.

In particular, the control unit 160 may divide a data file 10 to be stored into a file header 11 and file body 13 and store the file header 11 and file body 13 separately. In addition, the control unit 160 may combine a file header 11 and file body 13 that are stored separately to restore the original data file 10.

Before storage, the control unit 160 can insert a garbage value 15 into the file body 13 and add a garbage pointer field 17 to the file header 11 using a preset algorithm. The garbage pointer field 17 may contain data regarding the garbage value 15, such as its size and start location.

To restore the original data file 10, the control unit 160 first refers to the file header 11 to check whether a garbage value 15 is present. If a garbage value 15 is present, the control unit 160 removes the garbage value 15 and the garbage pointer field 17.

Although not shown, the mobile terminal 100 of this exemplary embodiment of the present invention may further include a wireless communication module for communication through a mobile communication network, a broadcast receiving module, a connector for battery charging, and a supplementary module, such as a music player module. The mobile terminal 100 may further include other units or modules for digital convergence.

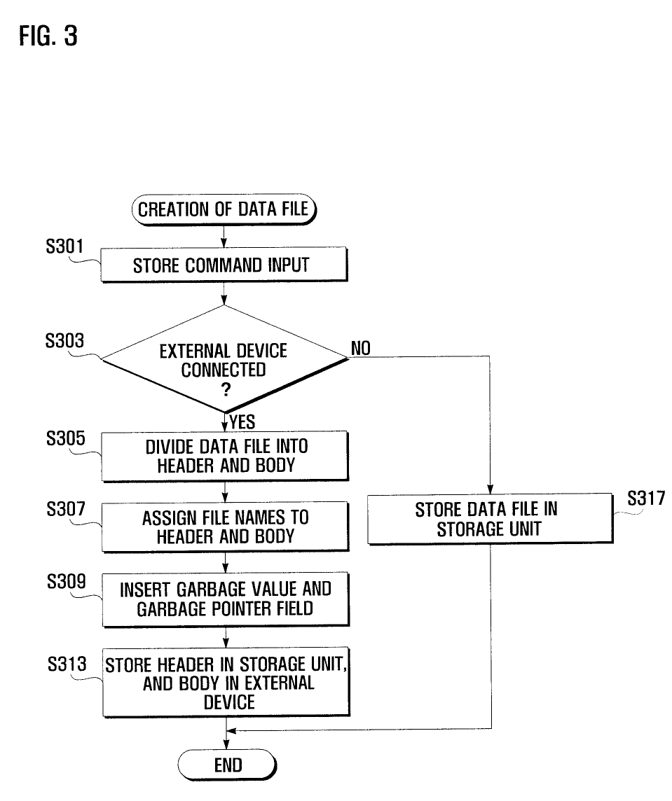

FIG. 3 is a flow chart showing a file storing procedure in the data file processing method of FIG. 1. In the exemplary embodiment of FIG. 3, the mobile terminal 100 performs a multimedia function, such as photographing, and creates a data file, such as an image file or video file.

Referring to FIG. 3, when a data file 10 is created, the user inputs a file name through the input unit 130. The created data file 10 may be an image file having a file name of ‘diversity’ (namely, ‘diversity.jpg’ when a filename extension is included).

When a store command is input through the input unit 130 (S301), the control unit 160 checks whether an external device 200 is connected to the mobile terminal 100 (S303).

If an external device 200 is connected, the control unit 160 divides the data file 10 into a file header 11 and a file body 13 (S305).

The control unit 160 assigns file names including extensions to the file header 11 and the file body 13 (S307). For example, the file names ‘diversity.hd’ and ‘diversity.bd’ may be respectively assigned to the file header 11 and the file body 13, so that the data file 10, the file header 11, and the file body 13 have the same file name except for the file name extension.

The control unit 160 inserts a garbage value 15 at a preset location (for example, at the beginning) of the file body 13 and adds a garbage pointer field 17, which provides information regarding the garbage value 15, to a preset location (for example, at the beginning) of the file header 11 (S309).

The control unit 160 stores the file header 11 in the storage unit 140 of the mobile terminal 100 and stores the file body 13 in the external device 200 (S313).

If an external device 200 is not connected at step S303, the control unit 160 stores the data file 10 in the storage unit 140 (S317).

As described above, when only the file body 13 of a data file 10 is stored in an external device 200, other persons may not be able to restore the data file 10 using the external device 200. Therefore, this exemplary embodiment of the present invention may improve data security.

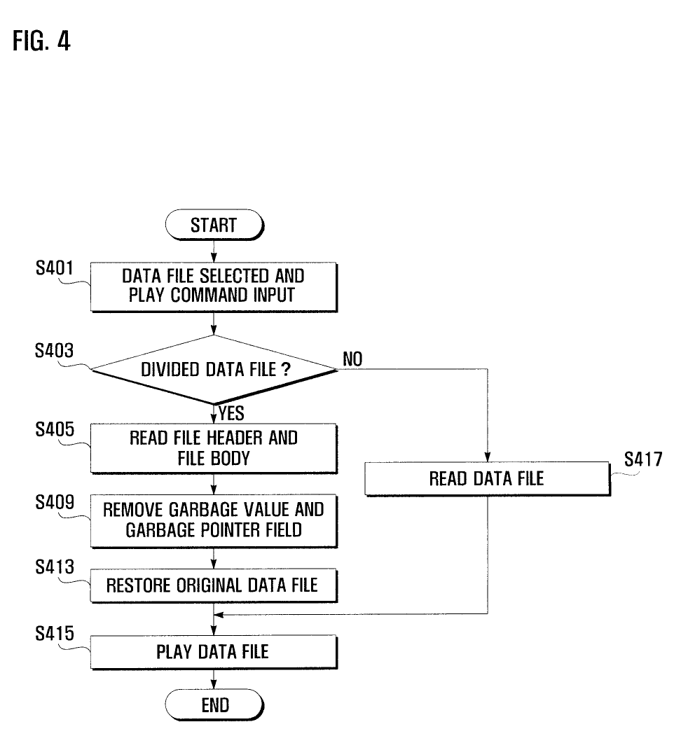

FIG. 4 is a flow chart showing a file restoring procedure in the data file processing method of FIG. 1. An external device 200 is connected to the mobile terminal 100.

During execution of a multimedia function, when a data file 10 is selected by the user and a play command is input through the input unit 130 (S401), the control unit 160 checks whether the data file 10 to be played is a divided data file (S403).

If the data file 10 is a divided data file, the control unit 160 reads a file header 11, which has a file name identical to that of the data file 10 except for the file name extension, from the storage unit 140 and reads a file body 13, which has a file name identical to that of the data file 10 except for the file name extension, from the external device 200 (S405).

The control unit 160 removes a garbage value 15 from the file body 13 and removes a garbage pointer field 17 from the file header 11 (S409). For example, with reference to the garbage pointer field 17, the control unit 160 identifies the start location of the garbage value 15 and deletes data according to the size of the garbage value 15 from the identified start location thereof in the file body 13.

The control unit 160 restores the data file 10 by combining the file header 11 and file body 13 together (S413).

Thereafter, the control unit 160 plays the data file 10 according to information stored in the file header 11 (S415). For example, if the data file 10 is an image file, the file header 11 may include a corresponding encoding scheme. The control unit 160 may decode the file body 13 using the encoding scheme and display the decoded file body 13 through the display unit 190.

If the data file 10 is not a divided data file at step S403, the control unit 160 reads the data file 10 from the storage unit 140 (S417) and plays the data file 10.

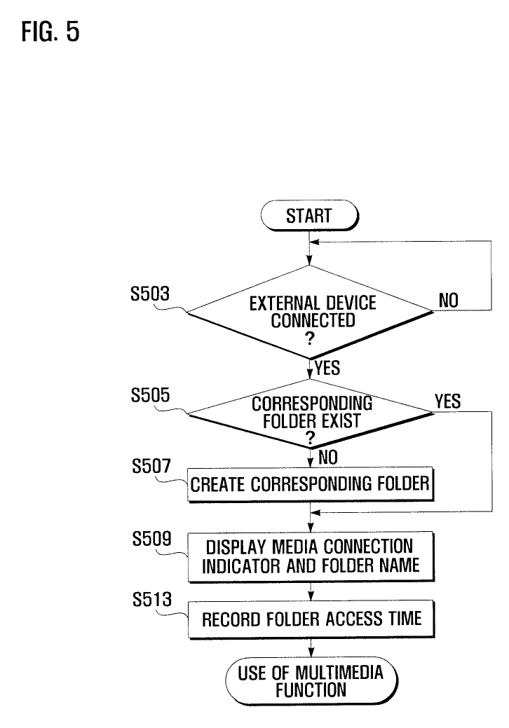

FIG. 5 is a flow chart showing a procedure of utilizing an external device, such as a removable storage medium. Two or more external devices can be used.

Referring to FIG. 5, the control unit 160 verifies that no external device is connected.

When an external device 200 is connected to the mobile terminal 100 (S503), the control unit 160 checks for the presence of a folder corresponding to the external device 200 (S505). The control unit 160 can distinguish between removable storage media using their media identifiers.

If a folder corresponding to the external device 200 is absent, the control unit 160 creates a folder corresponding to the external device 200 in the storage unit 140 (S507). The name of the created folder may reflect the media identifier of the external device 200.

Thereafter, the control unit 160 displays a media connection indicator indicating connection of the external device 200 through the display unit 190 and displays the name of the corresponding folder (S509).

The control unit 160 records the current time as the access time of the connected external device 200 (S513). Later, if a preset time duration has elapsed after the most recent connection of the external device 200, the corresponding folder can be regarded as unnecessary and be removed, which may avoid wasting resources.

Thereafter, a multimedia function, such as photographing, can be performed according to user commands and a data file 10, such as an image or motion picture file, can be created. When storing the data file 10, the file header 11 of the data file 10 may be stored in the corresponding folder of the storage unit 140 and the file body 13 may be stored in the external device 200, as described in connection with FIG. 3.

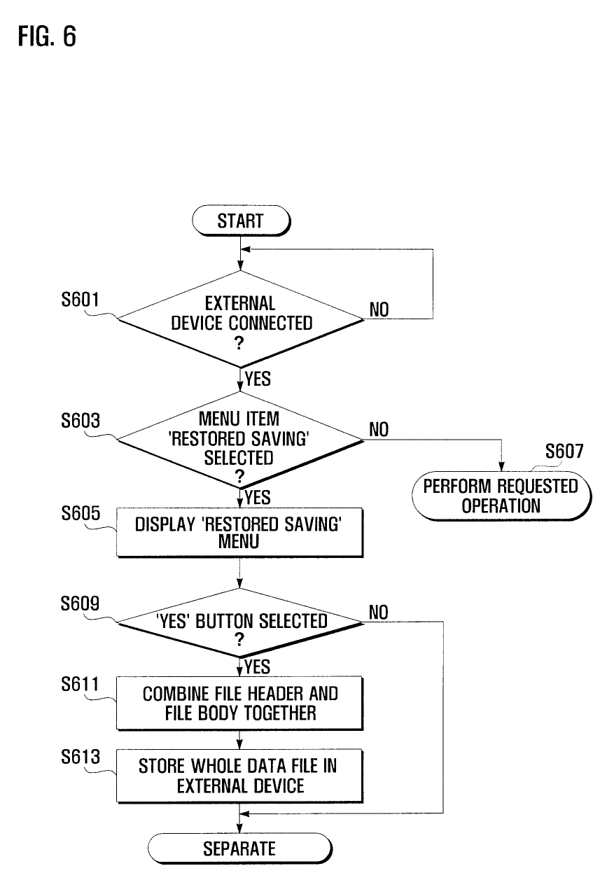

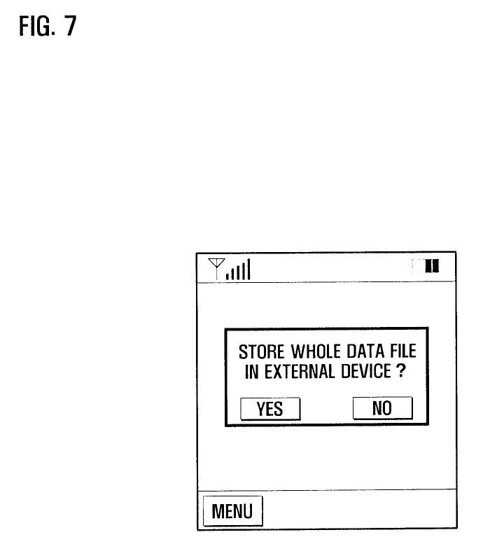

FIG. 6 is a flow chart showing a procedure of performing an optional function using an external device, such as a removable storage medium. The procedure of FIG. 6 is related to storage of a whole data file in an external device. FIG. 7 shows a screen representation for the procedure of FIG. 6.

Referring to FIG. 6, the control unit 160 verifies that an external device 200 is connected to the mobile terminal 100 (S601). Here, the file header 11 of a data file 10 is stored in a folder of the storage unit 140, and the file body 13 is stored in the external device 200.

In response to selection of a menu item by the user, the control unit 160 checks whether the selected menu item is ‘restored saving’ (S603).

If the selected menu item is not ‘restored saving,’ the control unit 160 performs an operation associated with the selected menu item (S607).

If the selected menu item is ‘restored saving,’ the control unit 160 displays a ‘restored saving’ selection menu in a pop-up window as shown in FIG. 7 (S605).

In response to selection of a button through, for example, a soft key, the control unit 160 checks whether the selected button is a ‘yes’ button (S609).

If the selected button is a ‘yes’ button, the control unit 160 combines the file header 11 stored in the folder and the file body 13 stored in the external device 200 to restore the data file 10 (S611), and stores the restored data file 10 in the external device 200 (S613).

If the selected button is a ‘no’ button, the control unit 160 maintains the current state in which the file header 11 is stored in the folder of the storage unit 140 and the file body 13 is stored in the external device 200.

As described above, a whole data file can be stored in an external device, such as a removable storage medium, according to a user selection.

As apparent from the above description, exemplary embodiments of the present invention provide a file processing method and an apparatus for a mobile terminal using an external device, such as a removable storage medium, wherein a data file is divided into a file header and a file body, the file header is stored in a storage unit of the mobile terminal, and the file body is stored in the external device. As a result, it may be difficult for other persons to restore the data file, thereby increasing the level of data security.

While the description above is focused on an image file, the present invention is not limited to an image file. For example, a moving image file may include video data and audio data. The video data and audio data can be divided into file headers and file bodies. The file header and file body of the video data can be separately stored. The file header and file body of the audio data can also be separately stored. Further, exemplary embodiments of the present invention can be applied to all kinds of files that can be divided into file headers and file bodies.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A file processing apparatus for a mobile terminal, comprising:
a storage unit to store files; and
a control unit to divide a data file into a file header and a file body, to store the file header in the storage unit, and to store the file body in an external device.

2. The file processing apparatus of claim 1, wherein the external device comprises a removable storage medium.

3. The file processing apparatus of claim 1, wherein the control unit adds a garbage value into the file body and adds a garbage pointer field indicating the garbage value to the file header, prior to storing the file header and file body.

4. The file processing apparatus of claim 1, wherein the control unit combines the file header and file body together to restore the data file.

5. The file processing apparatus of claim 4, wherein the control unit removes a corresponding garbage value from the file body if the file header has a garbage pointer field and removes the garbage pointer field from the file header, prior to combining the file header and file body.

6. The file processing apparatus of claim 1, wherein the external device has a media identifier to distinguish between different external devices.

7. The file processing apparatus of claim 1, wherein the control unit creates a folder corresponding to the external device when the external device is connected.

8. The file processing apparatus of claim 7, wherein the control unit deletes the folder if a time duration has elapsed after the most recent connection of the external device.

9. The file processing apparatus of claim 1, wherein the control unit stores the file header in a folder created to correspond to the external device.

10. A method for storing a file for a mobile terminal connected to an external device, comprising:
dividing a data file into a file header and a file body in response to a command signal to store the data file;
storing the file header in a storage unit of the mobile terminal; and
storing the file body in the external device.

11. The file storing method of claim 10, wherein the external device is a removable storage medium.

12. The file storing method of claim 10, further comprising:
adding a garbage value into the file body prior to storing the file header and file body; and
adding a garbage pointer field indicating the garbage value to the file header.

13. The file storing method of claim 10, wherein the file header is stored in a folder corresponding to the external device.

14. The file storing method of claim 13, wherein the folder is deleted if a time duration has elapsed after the most recent connection of the external device.

15. The file storing method of claim 10, further comprising:
combining the file header and the file body to restore the data file in response to a selection signal; and
storing the restored data file in the external device.

16. A file restoring method for a mobile terminal connected to an external device, comprising:
reading a file header and a file body corresponding to a data file in response to a command signal to play the data file; and
combining the file header and the file body to restore the data file.

17. The file restoring method of claim 16, wherein the data file is restored according to information stored in the file header.

18. The file restoring method of claim 17, wherein a garbage value is removed from the file body if the file header has a corresponding garbage pointer field, and the garbage pointer field is removed from the file header, prior to combination of the file header and file body.

19. The file restoring method of claim 16, wherein reading a file header and a file body comprises reading files having a file name identical to that of the data file except for a file extension.

20. The file restoring method of claim 16, wherein reading a file header and file body comprises reading the file header from a storage unit of the mobile terminal and reading the file body from the external device.

21. The file restoring method of claim 20, wherein the file header is read from a folder corresponding to the external device.

22. The file restoring method of claim 21, wherein the folder is deleted if a time duration has elapsed after the most recent connection of the external device.
